(19) United States
(12) Patent Application Publication
(10) Pub. No.: US 2018/0262905 A1
(43) Pub. Date: Sep. 13, 2018

(54) USER EQUIPMENT (UE) CAPABILITY DETERMINATION

(71) Applicant: QUALCOMM Incorporated, San Diego, CA (US)

(72) Inventors: Muthukumaran Dhanapal, Sunnyvale, CA (US); Srinivasan Balasubramanian, Sunnyvale, CA (US); Keiichi Kubota, San Diego, CA (US); Shravan Kumar Raghunathan, San Diego, CA (US); Parthasarathy Krishnamoorthy, San Diego, CA (US); Akash Kumar, Hyderabad (IN); Ankita, Hyderabad (IN)

(21) Appl. No.: 15/913,398

(22) Filed: Mar. 6, 2018

Related U.S. Application Data
(60) Provisional application No. 62/468,703, filed on Mar. 8, 2017.

(51) Int. Cl. H04W 8/24; H04W 76/11; H04L 5/00

(52) U.S. Cl. CPC H04W 8/24; H04L 5/001; H04W 76/11

(57) ABSTRACT

A base station may transmit to a user equipment (UE) one or more indices corresponding to one or more carrier aggregation (CA) band combinations via a UE capability request. The transmitted UE capability requests may include an identifier that corresponds to the UE or the capability procedure between the UE and the base station. Then the UE may respond to the request by including the identifier and an indication of its capability corresponding to the transmitted indices in a UE capability response. Additionally the UE may include an aggregation indicator which signals to the network that the UE's capabilities are to be aggregated with additional indications of UE capability received in other UE capability responses that also include the identifier. Subsequent UE capability responses that include the identifier and an indication that the UE's capabilities may be aggregated will be combined with previously received UE capabilities.

### CROSS REFERENCES

The present Application for Patent claims priority to U.S. Provisional Patent Application No. 62/468,703 by Dhanapal et al., entitled “User Equipment (UE) Capability Determination,” filed Mar. 8, 2017, assigned to the assignee hereof.

### BACKGROUND

The following relates generally to wireless communication, and more specifically to enhanced UE capability determination.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems, (e.g., a Long Term Evolution (LTE) system, or a New Radio (NR) system). A wireless multiple-access communications system may include a number of base stations or access network nodes, each simultaneously supporting communication for multiple communication devices, which may be otherwise known as user equipment (UE).

In many cases, a UE may transmit its capabilities (in the form of UE capability information) to a network (in many cases during an initial registration process). However, wireless technologies have become increasingly more complex and new technological features or capabilities are continually added to UEs. The result has been that the amount of UE capability information that is transmitted to a network has also increased. For example, a UE may have a 2 band downlink (DL) carrier aggregation (CA) capability supporting 32 different bands (e.g., LTE bands). In such a scenario, there may be 496 different 2-band combinations supported by the UE, all of which may be included in the UE capability information. Thus, when the UE transmits CA capabilities to a base station, the UE may need to report 496 different combinations to the base station. If either carrier in the 2-band CA combinations may be used for uplink, the UE may transmit the combinations twice, resulting in 992 (496×2) combinations to be transmitted. If each combination is four bytes, a message containing UE capabilities for CA may be 3968 bytes. In some cases, a UE may be operating with 3 band DL CA, which may involve even more bytes for transmitting the UE capabilities.

Therefore, UE capability information communication may be inefficient. Such transmissions not only are relatively large but, if transmitted, may utilize a large amount of frequency and time resources, lead to increased transmission times (which may lead to increased attach procedure times), and increased power usage at both the UE and the network. Improved methods of communication between the base station and the UE are desired.

### SUMMARY

The described techniques relate to improved methods, systems, devices, or apparatuses that support enhanced user equipment (UE) capability determination. Generally, the described techniques provide for the acquisition of UE capabilities by a network as part of a capability procedure. A base station may transmit indices to a UE that correspond to network-supported carrier aggregation (CA) band combinations via a UE capability request. The transmitted UE capability requests may include an identifier that corresponds to the UE or the capability procedure between the UE and the base station. Then the UE may transmit a UE capability response which may include the identifier and an indication of the UE's capability corresponding to the indices from the base station. Additionally the UE may include an aggregation indicator which signals to the base station that the UE's capabilities are to be aggregated with additional indications of UE capability received by the base station. In this way, UE capabilities reported in a series of UE capability responses (which may be smaller than using a single UE capability response) may be aggregated at the base station.

A method of wireless communication is described. The method may include identifying at least one of one or more carrier aggregation (CA) band combinations supportable by the base station, transmitting to a user equipment (UE) a UE capability request as part of a capability procedure, the UE capability request including one or more indices corresponding to the at least one of one or more CA band combinations, and receiving, from the UE, a UE capability response that includes one or more indications of UE capability corresponding to the one or more indices.

An apparatus for wireless communication is described. The apparatus may include means for identifying at least one of one or more carrier aggregation (CA) band combinations supportable by the base station, means for transmitting to a user equipment (UE) a UE capability request as part of a capability procedure, the UE capability request including one or more indices corresponding to the at least one of one or more CA band combinations, and means for receiving, from the UE, a UE capability response that includes one or more indications of UE capability corresponding to the one or more indices.

Another apparatus for wireless communication is described. The apparatus may include a processor, memory in electronic communication with the processor, and instructions stored in the memory. The instructions may be operable to cause the processor to identify at least one of one or more carrier aggregation (CA) band combinations supportable by the base station, transmit to a user equipment (UE) a UE capability request as part of a capability procedure, the UE capability request including one or more indices corresponding to the at least one of one or more CA band combinations, and receive, from the UE, a UE capability response that includes one or more indications of UE capability corresponding to the one or more indices.

A non-transitory computer readable medium for wireless communication is described. The non-transitory computer-readable medium may include instructions operable to cause a processor to identify at least one of one or more carrier aggregation (CA) band combinations supportable by the base station, transmit to a user equipment (UE) a UE capability request as part of a capability procedure, the UE capability request including one or more indices corresponding to the at least one of one or more CA band combinations, and receive, from the UE, a UE capability response that includes one or more indications of UE capability corresponding to the one or more indices.

Some examples of the method, apparatus, and non-transitory computer-readable medium described above may further include processes, features, means, or instructions for including in the UE capability request an identifier corresponding to the UE. Some examples of the method, apparatus, and non-transitory computer-readable medium described above may further include processes, features, means, or instructions for receiving, in the UE capability response, the identifier and an aggregation indicator indicating whether the one or more indications of UE capability in the UE capability response may be to be aggregated with additional indications of UE capability in previously received UE capability responses that include the identifier.

In some examples of the method, apparatus, and non-transitory computer-readable medium described above, transmitting the UE capability request comprises: transmitting a first UE capability request that includes a first set of the one or more indices corresponding to a first set of the at least one of one or more CA band combinations. Some examples of the method, apparatus, and non-transitory computer-readable medium described above may further include processes, features, means, or instructions for transmitting a second UE capability request that includes a second set of the one or more indices corresponding to a second set of the at least one of one or more CA band combinations, and including an identifier corresponding to the UE in both the first UE capability request and the second UE capability request.

In some examples of the method, apparatus, and non-transitory computer-readable medium described above, receiving the UE capability response comprises: receiving a first UE capability response and a second UE capability response. Some examples of the method, apparatus, and non-transitory computer-readable medium described above may further include processes, features, means, or instructions for storing, in association with the identifier, the one or more indications of UE capability from at least one of the first UE capability response or the second UE capability response.

Some examples of the method, apparatus, and non-transitory computer-readable medium described above may further include processes, features, means, or instructions for aggregating the one or more indications of UE capability received in the first UE capability response and in the second UE capability response based at least in part on an aggregation indicator included in the second UE capability response and associated with the identifier.

Some examples of the method, apparatus, and non-transitory computer-readable medium described above may further include processes, features, means, or instructions for including in the UE capability request an identifier that corresponds with and may be unique to the capability procedure between the UE and the base station.

Some examples of the method, apparatus, and non-transitory computer-readable medium described above may further include processes, features, means, or instructions for generating the identifier based at least in part on at least one of a base station identifier of the base station or a random number generated by the base station.

In some examples of the method, apparatus, and non-transitory computer-readable medium described above, the one or more indications of UE capability may be each one bit.

Some examples of the method, apparatus, and non-transitory computer-readable medium described above may further include processes, features, means, or instructions for receiving, in the UE capability response, one or more additional indications of UE capability that do not correspond to the one or more indices.

Some examples of the method, apparatus, and non-transitory computer-readable medium described above may further include processes, features, means, or instructions for receiving the one or more additional indications of UE capability in a non-critical extension of the UE capability response.

In some examples of the method, apparatus, and non-transitory computer-readable medium described above, the at least one of the one or more CA band combinations to which the indices correspond may be associated with one or more supported multiple input multiple output (MIMO) modes.

Some examples of the method, apparatus, and non-transitory computer-readable medium described above may further include processes, features, means, or instructions for receiving, in the UE capability response, at least one of an identifier or an aggregation indicator indicating whether the one or more indications of UE capability in the UE capability response may be to be aggregated with additional indications of UE capability in previously received UE capability responses that include the identifier.

A method of wireless communication is described. The method may include receiving, from a base station, a UE capability request as part of a capability procedure, the UE capability request including one or more indices corresponding to one or more carrier aggregation (CA) band combinations supportable by the base station and transmitting, to the base station, a UE capability response that includes one or more indications of UE capability corresponding to the one or more indices.

An apparatus for wireless communication is described. The apparatus may include means for receiving, from a base station, a UE capability request as part of a capability procedure, the UE capability request including one or more indices corresponding to one or more carrier aggregation (CA) band combinations supportable by the base station and means for transmitting, to the base station, a UE capability response that includes one or more indications of UE capability corresponding to the one or more indices.

Another apparatus for wireless communication is described. The apparatus may include a processor, memory in electronic communication with the processor, and instructions stored in the memory. The instructions may be operable to cause the processor to receive, from a base station, a UE capability request as part of a capability procedure, the UE capability request including one or more indices corresponding to one or more carrier aggregation (CA) band combinations supportable by the base station and transmit, to the base station, a UE capability response that includes one or more indications of UE capability corresponding to the one or more indices.

A non-transitory computer readable medium for wireless communication is described. The non-transitory computer-readable medium may include instructions operable to cause a processor to receive, from a base station, a UE capability request as part of a capability procedure, the UE capability request including one or more indices corresponding to one or more carrier aggregation (CA) band combinations supportable by the base station and transmit, to the base station, a UE capability response that includes one or more indications of UE capability corresponding to the one or more indices.

Some examples of the method, apparatus, and non-transitory computer-readable medium described above may further include processes, features, means, or instructions for receiving in the UE capability request an identifier corresponding to the UE. Some examples of the method, apparatus, and non-transitory computer-readable medium described above may further include processes, features, means, or instructions for transmitting, in the UE capability response, the identifier and an aggregation indicator indicating whether the one or more indications of UE capability in the UE capability response may be to be aggregated with additional indications of UE capability in previously transmitted UE capability responses that include the identifier.

In some examples of the method, apparatus, and non-transitory computer-readable medium described above, receiving the UE capability request comprises: receiving a first UE capability request that includes a first set of the one or more indices corresponding to a first set of the at least one of one or more CA band combinations. Some examples of the method, apparatus, and non-transitory computer-readable medium described above may further include processes, features, means, or instructions for receiving a second UE capability request that includes a second set of the one or more indices corresponding to a second set of the at least one of one or more CA band combinations, wherein an identifier may be included in both the first UE capability request and the second UE capability request.

In some examples of the method, apparatus, and non-transitory computer-readable medium described above, transmitting the UE capability response comprises: transmitting a first UE capability response and a second UE capability response, both the first UE capability response and the second UE capability response including the identifier. Some examples of the method, apparatus, and non-transitory computer-readable medium described above may further include processes, features, means, or instructions for indicating in at least the second UE capability response that the one or more indications of UE capability included in the first UE capability response and in the second UE capability response may be to be aggregated.

Some examples of the method, apparatus, and non-transitory computer-readable medium described above may further include processes, features, means, or instructions for receiving in the UE capability request an identifier that corresponds with and may be unique to the capability procedure between the UE and the base station.

In some examples of the method, apparatus, and non-transitory computer-readable medium described above, the one or more indications of UE capability may be each one bit.

Some examples of the method, apparatus, and non-transitory computer-readable medium described above may further include processes, features, means, or instructions for transmitting, in the UE capability response, one or more additional indications of UE capability that do not correspond to the one or more indices.

Some examples of the method, apparatus, and non-transitory computer-readable medium described above may further include processes, features, means, or instructions for transmitting the one or more additional indications of UE capability in a non-critical extension of the UE capability response.

In some examples of the method, apparatus, and non-transitory computer-readable medium described above, the at least one of the one or more CA band combinations to which the indices correspond may be associated with one or more supported multiple input multiple output (MIMO) modes.

Some examples of the method, apparatus, and non-transitory computer-readable medium described above may further include processes, features, means, or instructions for transmitting, in the UE capability response, at least one of an identifier or an aggregation indicator indicating whether the one or more indications of UE capability in the UE capability response may be to be aggregated with additional indications of UE capability in previously transmitted UE capability responses that include the identifier.

### BRIEF DESCRIPTION OF THE DRAWINGS

FIG. 1 illustrates an example of a system for wireless communication that supports enhanced user equipment (UE) capability determination in accordance with aspects of the present disclosure.

FIG. 2 illustrates an example of a wireless communications system 200 that supports enhanced UE capability determination in accordance with various aspects of the present disclosure.

FIG. 3 illustrates an example of a table 300 that is associated with enhanced UE capability determination in accordance with various aspects of the present disclosure.

FIG. 4 illustrates an example of a table 400 that supports enhanced UE capability determination in accordance with various aspects of the present disclosure.

FIG. 5 shows a flow diagram 500 that illustrates a UE capability procedure in accordance with aspects of the present disclosure.

FIG. 6 shows a flow diagram 600 that illustrates a UE capability procedure in accordance with aspects of the present disclosure.

FIGS. 7 through 9 show block diagrams of a device that supports enhanced UE capability determination in accordance with aspects of the present disclosure.

FIG. 10 illustrates a block diagram of a system including a base station that supports enhanced UE capability determination in accordance with aspects of the present disclosure.

FIGS. 11 and 12 show block diagrams of a device that supports enhanced UE capability determination in accordance with aspects of the present disclosure.

FIG. 13 illustrates a block diagram of a system including a UE that supports enhanced UE capability determination in accordance with aspects of the present disclosure.

FIGS. 14 through 17 illustrate methods for enhanced UE capability determination in accordance with aspects of the present disclosure.

### DETAILED DESCRIPTION

User equipments (UEs) operating in a wireless communications system may have a number of capabilities for supporting communication with a base station. UE capabilities may vary for different UEs (e.g., one UE may have a relatively large number of capabilities compared to another UE). When setting up a radio resource control (RRC) connection between a base station and a UE, a base station may utilize a UE capability process in determining how to configure communications with the UE. In the process, the UE may inform the base station of its various capabilities such as information on radio access technologies, the UE's power class, the frequency bands the UE is able to utilize, etc. Additionally, a UE may inform the base station of various carrier aggregation (CA) band combinations or multiple-input multiple-output (MIMO) modes that the UE may be able to support.

Because exchanging UE capability information may involve exchanging numerous configurations or features supported by a UE, a message carrying UE capabilities may be relatively large. With the added feature of CA in Long Term Evolution (LTE) or LTE-Advanced (LTE-A) networks, UE capability information message sizes have dramatically increased, as a UE may explicitly advertise all of the CA combinations the UE is able to support. Also, a UE may include in its UE capability messages each of the MIMO modes or other features that the UE is able to utilize in connection with each of the CA combinations. Due to this increase in capability information message size, network operators may have difficulty in processing these large messages which may result in attach failures between a network and a UE.

Accordingly, wireless systems may utilize an enhanced UE capability inquiry procedure to reduce the size of these capability information messages. The procedure may involve a base station indicating to a UE the CA combinations that the base station is able to support, Thus, instead of the base station receiving all supported capabilities from a UE, the base station may indicate to the UE only those capabilities that the base station is able to support, and the UE may respond to indicate which of the supported capabilities is also supported by the UE. In this way, a base station avoids receiving UE capability information about features the base station is not able to support. In order to further reduce message size, the UE capability inquiry procedure may utilize indices that correspond to CA band combinations. Indices may further correspond to respective CA band combinations as well as the MIMO modes or other features supported with those CA band combinations. Using indices reduces the amount of information transmitted between a base station and a UE relative to a conventional registration or attach protocol. Additionally, the UE and the base station may utilize signaling to indicate that sets of CA combinations supported by a UE may be aggregated with other sets of CA combinations also supported by the UE but reported in separate, smaller messages. As explained herein, some benefits of this technique may include reduced message sizes, reduced transmission time for capability information messages, and power savings.

Aspects of the disclosure are initially described in the context of a wireless communications system. Specific examples are described for transmitting a UE capability request to a UE, the UE capability request including one or more indices corresponding to one or more CA band combinations (with corresponding MIMO modes or other features with respect to the one or more CA band combinations). The examples describe receiving a UE capability response from the UE, where the UE capability response includes one or more indications of UE capability corresponding to the one or more indices. Aspects of the disclosure are further illustrated by and described with reference to apparatus diagrams, system diagrams, and flowcharts that relate to enhanced UE capability determination.

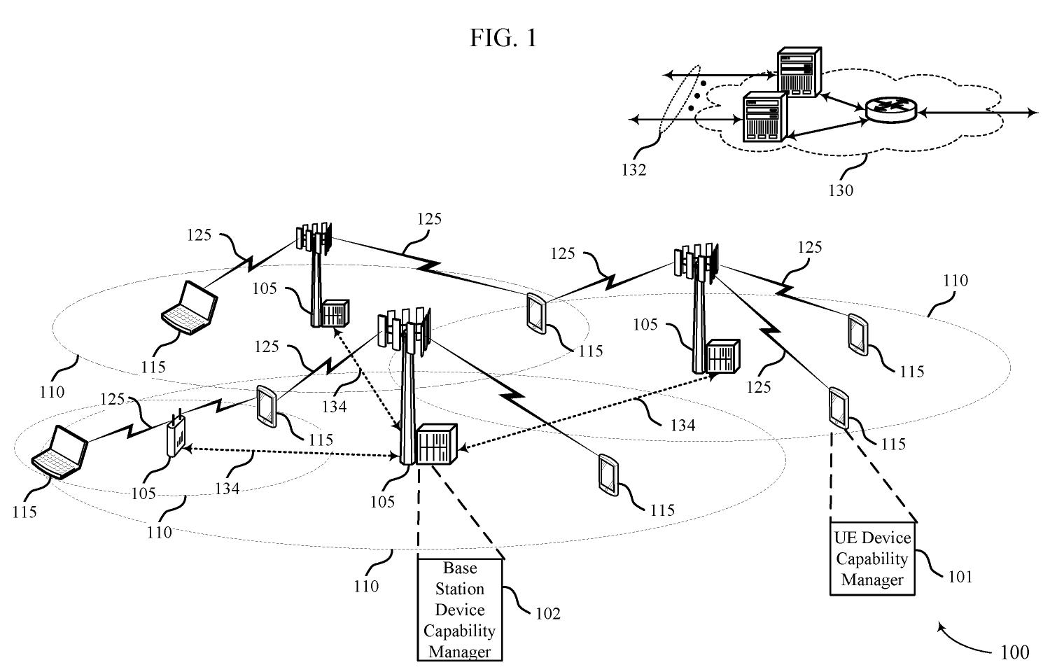

FIG. 1 illustrates an example of a wireless communications system 100 in accordance with various aspects of the present disclosure. The wireless communications system 100 includes base stations 105, UEs 115, and a core network 130. In some examples, the wireless communications system 100 may be an LTE, LTE-A network, or a New Radio (NR) network. In some cases, wireless communications system 100 may support enhanced broadband communications, ultra-reliable (i.e., mission critical) communications, low latency communications, and communications with low-cost and low-complexity devices. In some examples, a base station 105 may transmit a UE capability request to a UE, the UE capability request including indices corresponding to CA band combinations with corresponding MIMO modes or other features with respect to the CA band combinations. The base station 105 may then receive from the UE a UE capability response that includes indications of UE capability corresponding to the indices.

Base stations 105 may wirelessly communicate with UEs 115 via one or more base station antennas. Each base station 105 may provide communication coverage for a respective geographic coverage area 110. Communication links 125 shown in wireless communications system 100 may include uplink (UL) transmissions from a UE 115 to a base station 105, or downlink (DL) transmissions, from a base station 105 to a UE 115. Control information and data may be multiplexed on an uplink channel or downlink channel according to various techniques. Control information and data may be multiplexed on a downlink channel, for example, using time division multiplexing (TDM) techniques, frequency division multiplexing (FDM) techniques, or hybrid TDM-FDM techniques. In some examples, the control information transmitted during a transmission time interval (TTI) of a downlink channel may be distributed between different control regions in a cascaded manner (e.g., between a common control region and one or more UE-specific control regions).

UEs 115 may be dispersed throughout the wireless communications system 100, and each UE 115 may be stationary or mobile. A UE 115 may also be referred to as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may also be a cellular phone, a personal digital assistant (PDA), a wireless modem, a wireless communication device, a handheld device, a tablet computer, a laptop computer, a cordless phone, a personal electronic device, a handheld device, a personal computer, a wireless local loop (WLL) station, an Internet of things (IoT) device, an Internet of Everything (IoE) device, a machine type communication (MTC) device, an appliance, an automobile, or the like.

UEs 115 may include a UE device capability manager 101, which may receive, from a base station, a UE capability request that includes indices corresponding to CA band combinations supported by the base station, and transmit, to the base station, a UE capability response that includes indications of UE capability corresponding to the indices.

Base stations 105 may communicate with the core network 130 and with one another. For example, base stations 105 may interface with the core network 130 through backhaul links 132 (e.g., S1, etc.). Base stations 105 may communicate with one another over backhaul links 134 (e.g., X2, etc.) either directly or indirectly (e.g., through core network 130). Base stations 105 may perform radio configuration and scheduling for communication with UEs 115, or may operate under the control of a base station controller. In some examples, base stations 105 may be macro cells, small cells, hot spots, or the like. Base stations 105 may also be referred to as eNodeBs (eNBs) 105.

A base station 105 may be connected by an S1 interface to the core network 130. The core network may be an evolved packet core (EPC), which may include at least one mobility management entity (MME), at least one serving gateway (S-GW), and at least one Packet Data Network (PDN) gateway (P-GW). The MME may be the control node that processes the signaling between the UE 115 and the EPC. All user Internet Protocol (IP) packets may be transferred through the S-GW, which itself may be connected to the P-GW. The P-GW may provide IP address allocation as well as other functions. The P-GW may be connected to the network operators IP services. The operators IP services may include the Internet, the Intranet, an IP Multimedia Subsystem (IMS), and a Packet-Switched (PS) Streaming Service (PSS). The core network 130 may provide user authentication, access authorization, tracking, Internet Protocol (IP) connectivity, and other access, routing, or mobility functions.

Base station 105 may include a base station device capability manager 102, which may identify CA band combinations with corresponding MIMO modes or other features supported by the base station, transmit to a UE a UE capability request which may include indices corresponding to the supported CA band combinations, and receive, from the UE, a UE capability response that includes indications of UE capability corresponding to the indices.

Wireless communications system 100 may operate in an ultra-high frequency (UHF) frequency region using frequency bands from 700 MHz to 2600 MHz (2.6 GHz), although in some cases WLAN networks may use frequencies as high as 4 GHz. This region may also be known as the decimeter band, since the wavelengths range from approximately one decimeter to one meter in length. UHF waves may propagate mainly by line of sight, and may be blocked by buildings and environmental features. However, the waves may penetrate walls sufficiently to provide service to UEs 115 located indoors. Transmission of UHF waves is characterized by smaller antennas and shorter range (e.g., less than 100 km) compared to transmission using the smaller frequencies (and longer waves) of the high frequency (HF) or very high frequency (VHF) portion of the spectrum. In some cases, wireless communications system 100 may also utilize extremely high frequency (EHF) portions of the spectrum (e.g., from 30 GHz to 300 GHz). This region may also be known as the millimeter band, since the wavelengths range from approximately one millimeter to one centimeter in length. Thus, EHF antennas may be even smaller and more closely spaced than UHF antennas. In some cases, this may facilitate use of antenna arrays within a UE 115 (e.g., for directional beamforming). However, EHF transmissions may be subject to even greater atmospheric attenuation and shorter range than UHF transmissions.

Thus, wireless communications system 100 may support millimeter wave (mmW) communications between UEs 115 and base stations 105. Devices operating in mmW or EHF bands may have multiple antennas to allow beamforming. That is, a base station 105 may use multiple antennas or antenna arrays to conduct beamforming operations for directional communications with a UE 115. Beamforming (which may also be referred to as spatial filtering or directional transmission) is a signal processing technique that may be used at a transmitter (e.g. a base station 115) to shape and/or steer an overall antenna beam in the direction of a target receiver (e.g. a UE 115). This may be achieved by combining elements in an antenna array in such a way that transmitted signals at particular angles experience constructive interference while others experience destructive interference.

MIMO wireless systems use a transmission scheme between a transmitter (e.g. a base station) and a receiver (e.g. a UE), where both transmitter and receiver are equipped with multiple antennas. Some portions of wireless communications system 100 may use beamforming. For example, base station 105 may have an antenna array with a number of rows and columns of antenna ports that the base station 105 may use for beamforming in its communication with UE 115. Signals may be transmitted multiple times in different directions (e.g., each transmission may be beamformed differently). A mmW receiver (e.g., a UE 115) may try multiple beams (e.g., antenna subarrays) while receiving the synchronization signals.

In some cases, the antennas of a base station 105 or UE 115 may be located within one or more antenna arrays, which may support beamforming or MIMO operation. One or more base station antennas or antenna arrays may be collocated at an antenna assembly, such as an antenna tower. In some cases, antennas or antenna arrays associated with a base station 105 may be located in diverse geographic locations. A base station 105 may multiple use antennas or antenna arrays to conduct beamforming operations for directional communications with a UE 115.

Wireless communications system 100 may support operation on multiple cells or carriers, a feature which may be referred to as CA or multi-carrier operation. A carrier may also be referred to as a component carrier (CC), a layer, a channel, etc. The terms “carrier,” “component carrier,” “cell,” and “channel” may be used interchangeably herein. A UE 115 may be configured with multiple downlink CCs and one or more uplink CCs for carrier aggregation. Carrier aggregation may be used with both frequency division duplexing (FDD) and time division duplexing (TDD) component carriers.

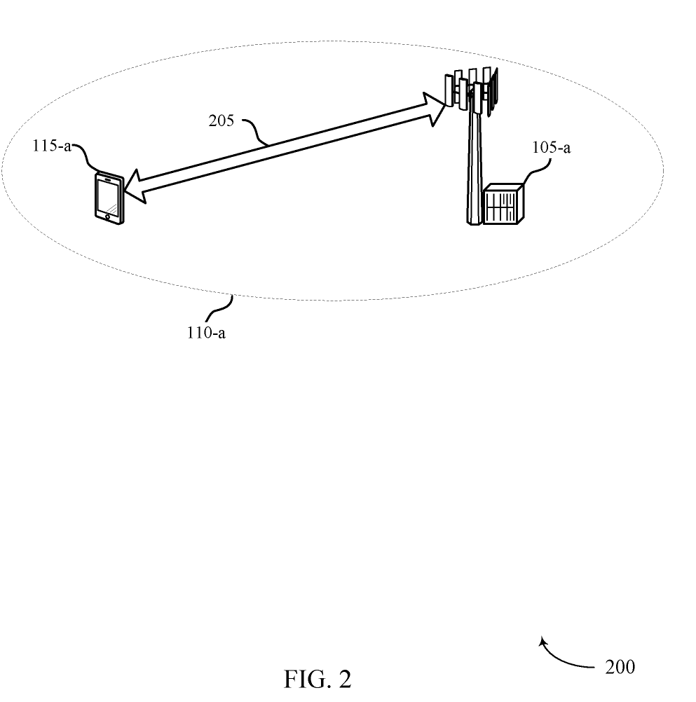

FIG. 2 illustrates an example of a wireless communications system 200 that supports enhanced UE capability determination in accordance with various aspects of the present disclosure. Wireless communications system 200 may include a base station 105-a and a UE 115-a, which may be examples of the corresponding devices described with reference to FIG. 1. UE 115-a and base station 105-a may communicate via bidirectional link 205 within coverage area 110-a. In some cases, bidirectional link 205 may be used for establishing an RRC connection or for UE capability communication.

For example, communication between UE 115-a and base station 105-a may include base station 105-a transmitting a UE capability request as part of a capability procedure to UE 115-a. Instead of the UE capability request merely indicating that the UE 115-a is to respond with all of its capabilities, the UE capability request may indicate those capabilities that the base station 105-a is able to support. The UE capability request may include indices corresponding to CA band combinations with corresponding MIMO modes, for example, supported by the base station 105-a. Communication from base station 105-a to UE 115-a may also include an identifier corresponding to the UE 115-a or to a capability procedure between the UE 115-a and the base station 105-a.

In response, UE 115-a may send a capability response message to base station 105-a as a part of the capability procedure. The capability response may include indications of UE capability corresponding to the indices transmitted from base station 105-a. The capability response may also include, either both alone or in combination, an aggregation indicator and an identifier corresponding to the UE 115-a or to the capability procedure between the UE 115-a and the base station 105-a. The capability response may also include indications of UE capability that do not correspond to the indices described above—indications of UE capability that were not requested by the base station 105-a but that the UE 115-a determines are still worth transmitting to the base station 105-a. These additional indications of UE capability may be transmitted in a non-critical extension of the UE capability response.

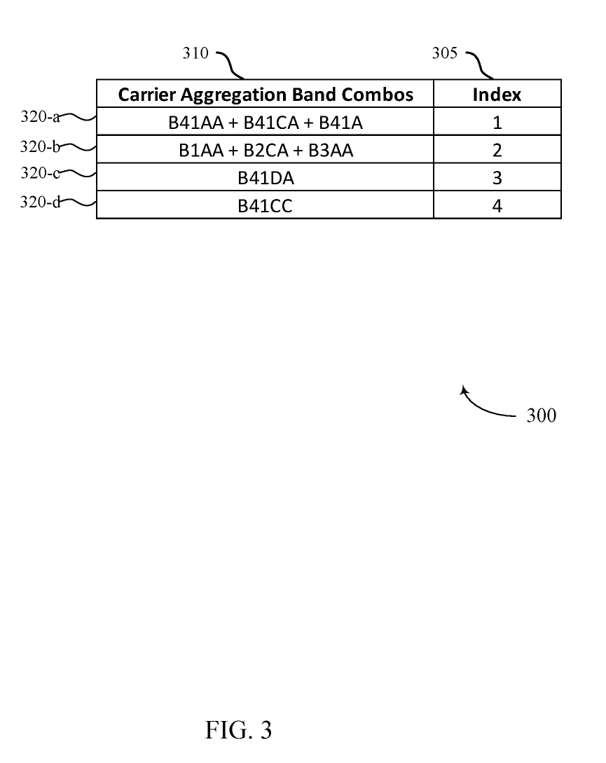

FIG. 3 illustrates an example of a table 300 that is associated with enhanced UE capability determination in accordance with various aspects of the present disclosure. Table 300 is comprised of index column 305, CA band combination column 310, and rows 320-a, 320-b, 320-c, and 320-d. Each row of CA band combination column 310 may be comprised of various combinations of CA bands that are supported by a base station. For purposes of simplicity, table 300 does not also indicate supported MIMO modes or other features in association with the supported CA band combinations. Nevertheless, each of the one or more CA band combinations indicated in table 300 may be associated with other supported features. For example, the CA band combination in row 320-a may be indicated to include MIMO capability by identifying the CA band combination as B41AA (4L MIMO on DL and 2L MIMO on UL)+B41CA (4L MIMO on DL and 2L MIMO on UL)+B41A (2L MIMO on DL and no UL support), Thus, another index (in index column 305) may be used to represent the same CA band combination having different MIMO capabilities or other features.

In a UE capability inquiry procedure, a base station may initiate the procedure by indicating to a UE sets of CA band combinations (along with associated MIMO modes or other features) that the base station is able to support. Using the information in table 300, which may be known by both the base station and a communicating UE, the base station may indicate the supported CA band combinations by using the corresponding indices (from index column 305). These indices may be mapped to specific CA band combinations (with corresponding MIMO modes or other features) that are referenced in technical specifications.

For example, row 320-a is associated with index 1 as specified by index column 305. As illustrated in row 320-a, CA band combinations B41AA, B41CA, and B41A may be mapped to index 1. Similarly, as illustrated in row 320-b, CA band combinations B1AA, B2CA, and B3AA may be mapped to index 2. In row 320-c, CA band combination B41DA is mapped to index 3. Row 320-d illustrates that CA band combination B41CC may be mapped to index 4.

Utilizing table 300, for example, a base station may transmit a UE capability request to a UE that is comprised of one or more indices. For example, the UE capability request may include indices that represent a list such as {1, 2, 4}. Upon receiving the list of indices, a UE may include in a UE capability response indications of its capability corresponding to each of the indices transmitted by the base station. The indications of UE capability may each be one bit (as in a Boolean True/False). For example, in response to the list of indices {1, 2, 4}, the UE may include in a portion of its UE capability response message a corresponding reply of {True, False, True}. A “True” reply indicates that the UE supports the CA band combination (and associated MIMO capabilities) corresponding to the particular index, and a “False” reply indicates that the UE does not support the CA band combination (and associated MIMO capabilities) corresponding to the particular index. In the example given, the UE may support the CA band combinations mapped to indices 1 and 4, but the UE does not support the CA band combination mapped to index 2. Additionally, a UE may respond to the UE capability request by explicitly indicating a series of CA band combinations along with MIMO modes or other features with respect to the CA band combinations. These additional series of CA band combinations may not correspond with the indices transmitted in the UE capability request, but may instead be indicated as part of a non-critical extension in the UE capability response.

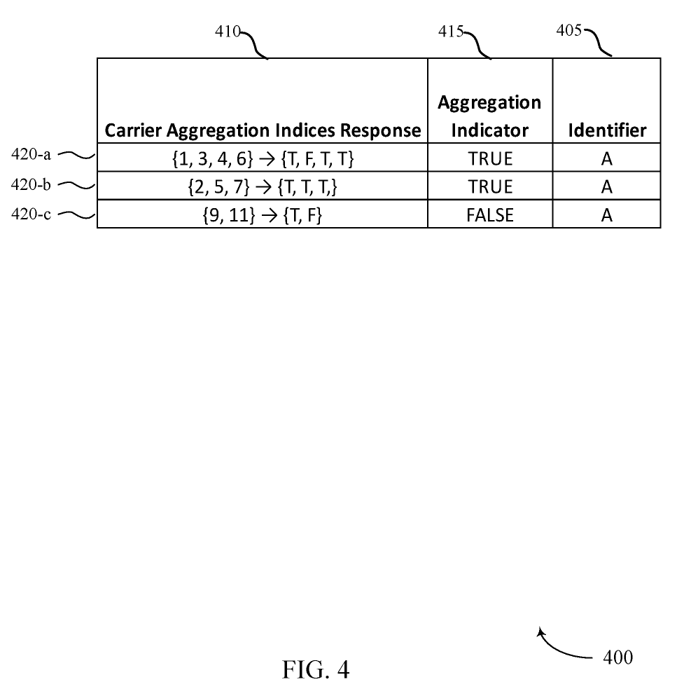

FIG. 4 illustrates an example of a table 400 that supports enhanced UE capability determination in accordance with various aspects of the present disclosure. Table 400 is comprised of identifier column 405, CA indices response column 410, aggregation indicator column 415, and rows 420-a, 420-b, and 420-c.

Table 400 may illustrate portions of UE capability response messages from a UE to a base station. Rows 420 may illustrate the portions of the UE capability response messages. The CA indices response column 410 may be one or more UE capabilities provided by a UE and corresponding to capability indices indicated by a base station in a UE capability request. For example, row 420-a illustrates that a base station may have transmitted a UE capability request comprising of indices {1, 3, 4, 6} with the UE responding to the indices with indications {T, F, T, T}. Additionally, a UE may have also included, with its UE capability response, an aggregation indicator and an identifier, as indicated in column 415 and 405, respectively, and as explained further below.

An identifier from identifier column 405 may correspond to the UE or it may correspond to and be unique to a capability procedure between the UE and the base station. The identifier may be included in the UE capability request message from the base station. The base station may generate the identifier from a base station identifier of the base station in combination with a random number generated by the base station. Alternatively, the base station may generate the identifier using some other method so as to generate an identifier that uniquely identifies a UE to the base station. The UE may associate the identifier with the UE capability request that the identifier was received in and include the identifier in a corresponding UE capability response. The base station may then be able to store the information contained within the UE capability response and uniquely associate the information with the UE using the identifier.

A UE may also include an aggregation indicator in a UE capability response, as may also be recorded in table 400. An aggregation indicator from aggregation indicator column 415 may signal to the base station that the base station may aggregate the supported CA band combinations associated with the UE capability response message that includes the aggregation indicator with other supported CA band combinations associated with other UE capability response messages. For example, row 420-a shows that the aggregation indicator included in a UE capability response associated with identifier A was “TRUE.” Therefore, the information contained within that particular UE capability response may be aggregated with additional indications of UE capability included in previously received UE capability responses that are associated with the same identifier A. In row 420-b, the aggregation indicator is “TRUE” and the identifier is the same as that in row 420-a, so a base station may aggregate the UE capabilities contained within row 420-b with the UE capabilities contained within row 420-a (and previously received UE capabilities associated with the same identifier A). In row 420-c, the aggregation indicator is “FALSE,” therefore the UE capabilities contained within row 420-c may not be aggregated with either the UE capabilities of row 420-a and 420-b, even though the identifier is the same. An aggregation indicator of “FALSE” may occur after the UE may have moved from one cell to another and changed its supported CA band combinations. In some embodiments, inclusion of an identifier without an aggregation indicator in a UE capability response may signal to the base station to automatically aggregate the response's UE capabilities with previously received UE capability responses that are associated with the same identifier.

By using an aggregation indicator, a base station may be enabled to send smaller UE capability requests. Instead of including all supported base station capabilities in an initial UE capability request, a base station may only include a subset of supported features in an initial UE capability request. The responses received to follow-up UE capability requests may be aggregated by the base station to provide a complete mapping of supported base station capabilities and corresponding supported UE capabilities.

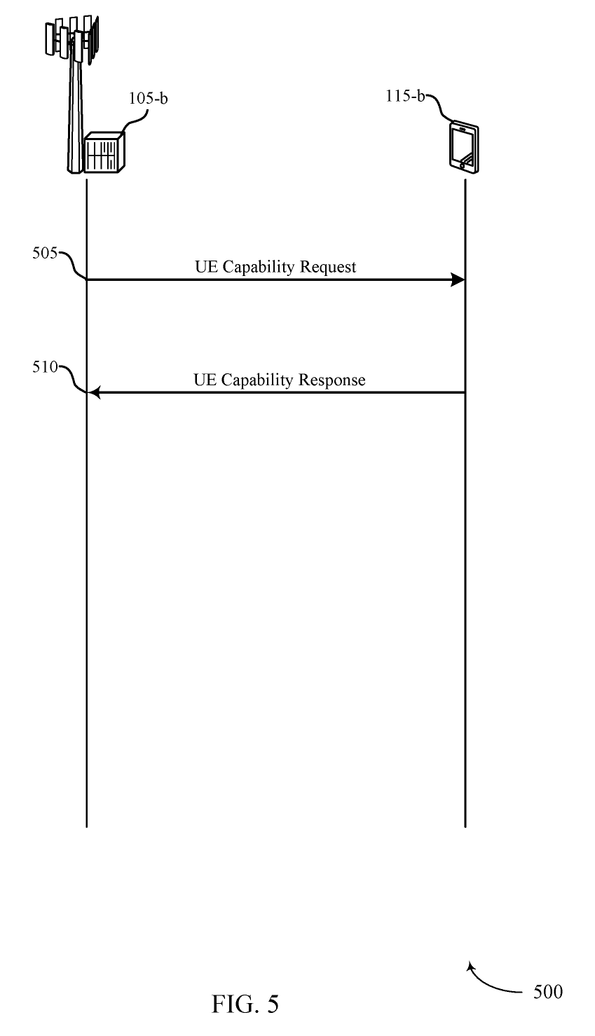

FIG. 5 shows a flow diagram 500 that illustrates a UE capability inquiry procedure between base station 105-b and UE 115-b. In some cases, flow diagram 500 may represent aspects of techniques performed by a UE 115 or base station 105 as described with reference to FIGS. 1 and 2. In initiating a UE capability inquiry procedure, base station 105-b may transmit a UE capability request 505 to UE 115-b. UE capability request 505 may include one or more indices that correspond to one or more CA band combinations (as well as additional features (e.g., MIMO capabilities) that may be in connection with the one or more CA band combinations) that the base station 105-b has identified that it can support.

Upon receiving UE capability request 505, UE 115-b may then transmit UE capability response 510 to base station 105-b. UE capability response 510 may include one or more indications of the UE's capability that correspond to the one or more received indices. UE 105-b may also explicitly indicate CA band combinations that it may support without the explicit indication corresponding to the received indices. This explicit indication may be contained within a non-critical extension of UE capability response 510.

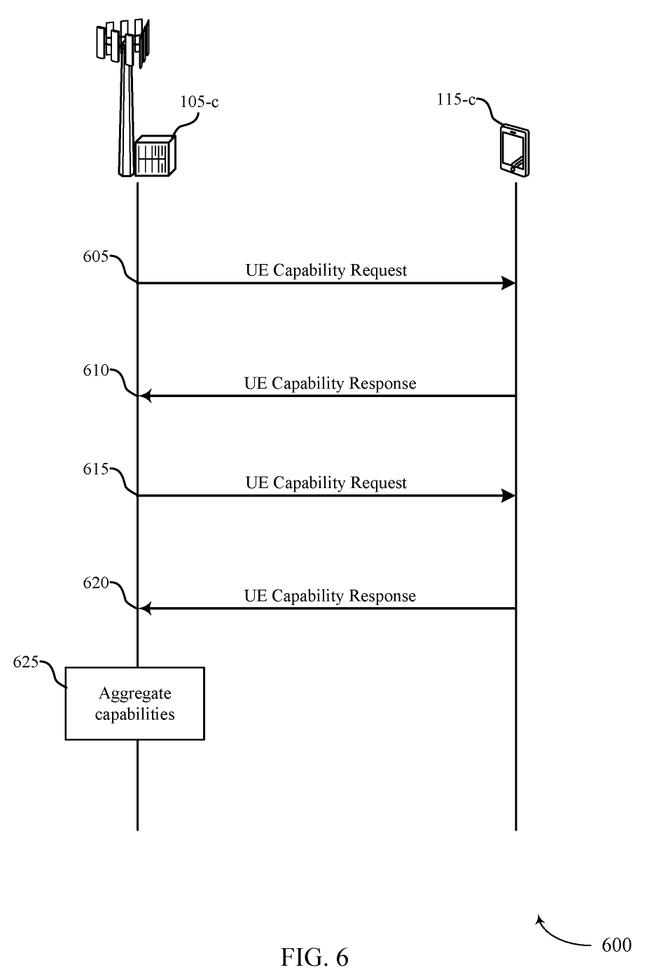

FIG. 6 shows a flow diagram 600 that illustrates a UE capability inquiry procedure between base station 105-c and UE 115-c. In some cases, flow diagram 600 may represent aspects of techniques performed by a UE 115 or base station 105 as described with reference to FIGS. 1 and 2. In initiating a UE capability inquiry procedure, base station 105-c may transmit a UE capability request 605 to UE 115-c. UE capability request 605 may include one or more indices that correspond to one or more CA band combinations (as well as additional features (e.g., MIMO capabilities) that may be in connection with the one or more CA band combinations) that the base station 105-c has identified that it can support. UE capability request 605 may include an identifier which may correspond to the UE or which may correspond to and be unique to a capability procedure between the UE and the base station. In one example, the base station may generate the identifier from a base station identifier of the base station in combination with a random number generated by the base station.

Upon receiving UE capability request 605, UE 115-c may then transmit UE capability response 610 to base station 105-c. UE capability response 610 may include one or more indications of the UE's capability that correspond to the one or more indices of UE capability request 605. UE capability response 610 may also include the identifier and an aggregation indicator. A positive aggregation indicator may signal to base station 105-c that the base station may aggregate the CA band combinations associated with UE capability response message 610 with other CA band combinations associated with other UE capability response messages having the same identifier. Base station 105-c may then store the indications of UE 115-c capabilities from UE capability response 610.

Base station 105-c may then transmit a subsequent UE capability request 615 to UE 115-c. UE capability request 615 may include one or more indices that correspond to one or more CA band combinations that the base station 105-c has identified that it can support. The indices of UE capability request 615 may be the same or different than the indices of UE capability request 605. UE capability request 615 may include an identifier which may be the same as the identifier in UE capability request 605.

Upon receiving UE capability request 615, UE 115-c may then transmit UE capability response 620 to base station 105-c. UE capability response 620 may include one or more indications of the UE's capability that correspond to the one or more indices of UE capability request 615. UE capability response 620 may also include the identifier and an aggregation indicator. A positive aggregation indicator may signal to base station 105-c that it may aggregate the CA band combinations associated with UE capability response message 620 with other CA band combinations associated with other UE capability response messages. This may include the CA band combinations associated with UE capability response message 610. Base station 105-c may then store the indications of UE 115-c capabilities from UE capability response 620.

At block 625, if both UE capability responses 610 and 620 include positive aggregation indicators, base station 105-c may aggregate the indications of UE capability contained within UE capability responses 610 and 620 since they are associated with the same identifier.

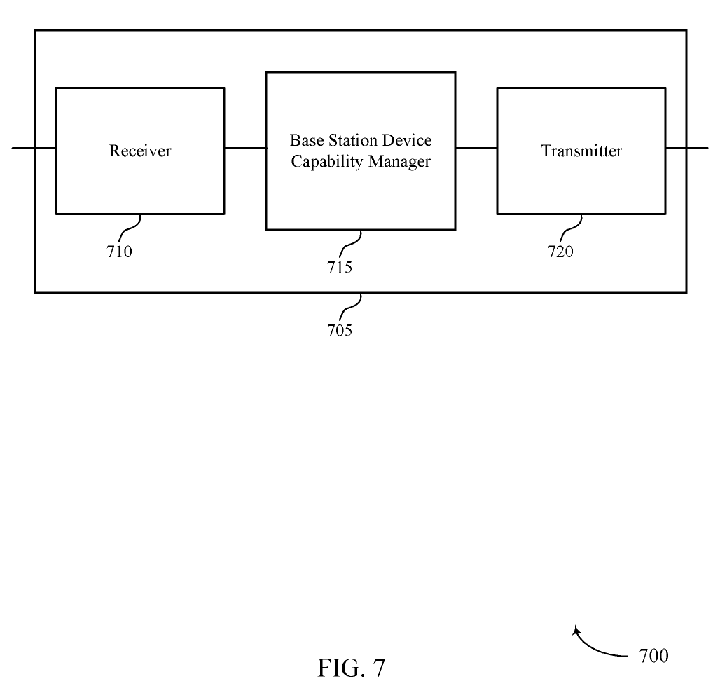

FIG. 7 shows a block diagram 700 of a wireless device 705 that supports enhanced UE capability determination in accordance with various aspects of the present disclosure. Wireless device 705 may be an example of aspects of a base station 105 as described with reference to FIG. 1. wireless device 705 may include receiver 710, base station device capability manager 715, and transmitter 720. wireless device 705 may also include a processor. Each of these components may be in communication with one another (e.g., via one or more buses).

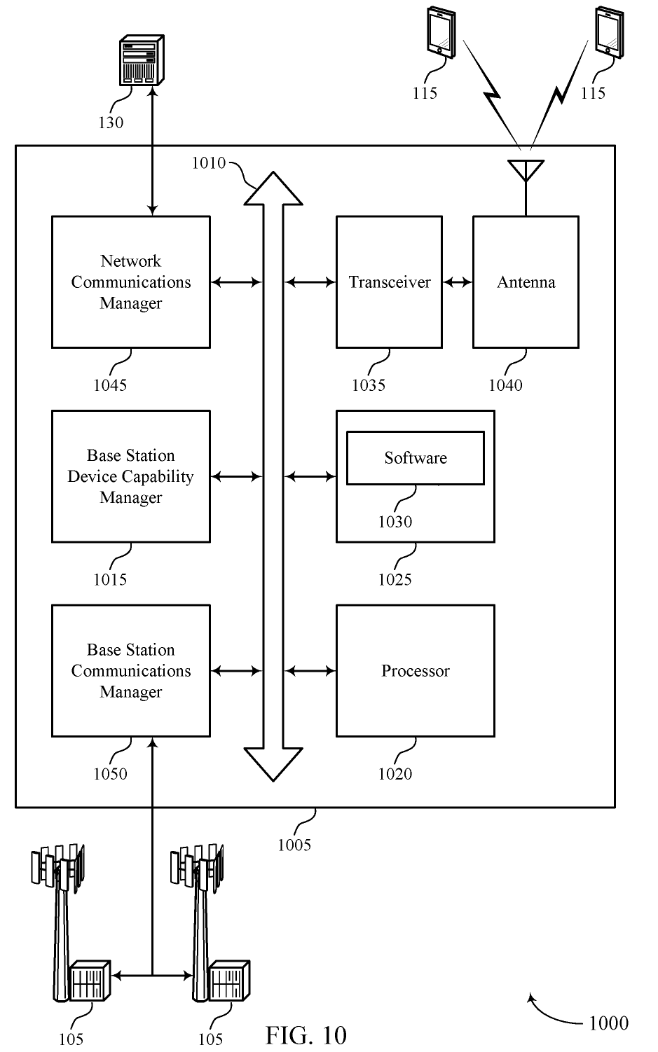

Receiver 710 may receive information such as packets, user data, or control information associated with various information channels (e.g., control channels, data channels, and information related to enhanced UE capability determination, etc.). Information may be passed on to other components of the device. The receiver 710 may be an example of aspects of the transceiver 1035 described with reference to FIG. 10.

Receiver 710 may receive a UE capability response that includes indications of UE capability corresponding to the one or more indices; receive an identifier and an aggregation indicator; receive one or more additional indications of UE capability that do not correspond to the indices; and receive the indications of UE capability in a non-critical extension of the UE capability response.

Base station device capability manager 715 may be an example of aspects of the base station device capability manager 1015 described with reference to FIG. 10. Base station device capability manager 715 may identify at least one of one or more CA band combinations (and associated MIMO modes, for example) supportable by the base station.

Base station device capability manager 715 and/or at least some of its various sub-components may be implemented in hardware, software executed by a processor, firmware, or any combination thereof. If implemented in software executed by a processor, the functions of the base station device capability manager 715 and/or at least some of its various sub-components may be executed by a general-purpose processor, a digital signal processor (DSP), an application-specific integrated circuit (ASIC), an field-programmable gate array (FPGA) or other programmable logic device, discrete gate or transistor logic, discrete hardware components, or any combination thereof designed to perform the functions described in the present disclosure. The base station device capability manager 715 and/or at least some of its various sub-components may be physically located at various positions, including being distributed such that portions of functions are implemented at different physical locations by one or more physical devices. In some examples, base station device capability manager 715 and/or at least some of its various sub-components may be a separate and distinct component in accordance with various aspects of the present disclosure. In other examples, base station device capability manager 715 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

Transmitter 720 may transmit signals generated by other components of the device. In some examples, the transmitter 720 may be collocated with a receiver 710 in a transceiver module. For example, the transmitter 720 may be an example of aspects of the transceiver 1035 described with reference to FIG. 10. The transmitter 720 may include a single antenna, or it may include a set of antennas.

Transmitter 720 may transmit a UE capability request as part of a capability procedure, the UE capability request including one or more indices corresponding to the at least one of one or more CA band combinations or one or more MIMO modes.

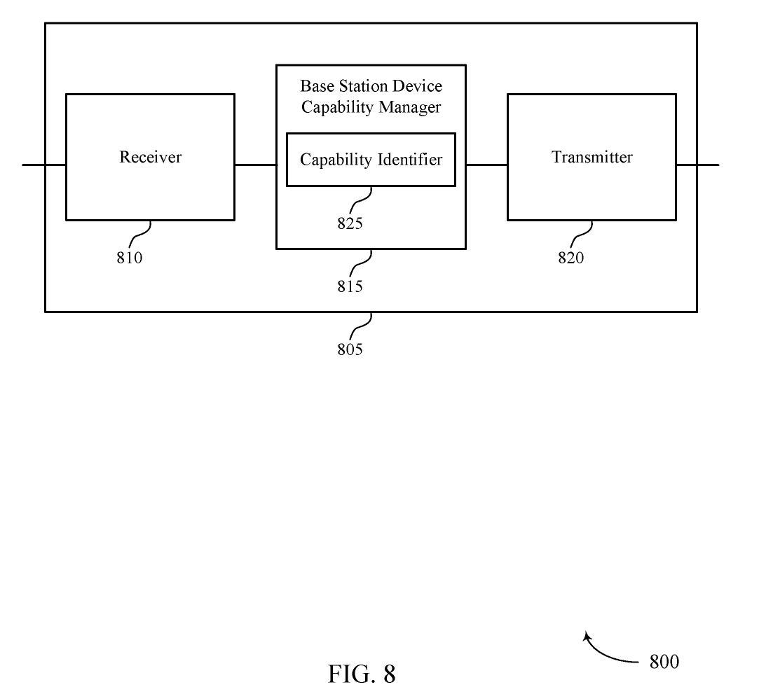

FIG. 8 shows a block diagram 800 of a wireless device 805 that supports enhanced UE capability determination in accordance with various aspects of the present disclosure. Wireless device 805 may be an example of aspects of a wireless device 705 or a base station 105 as described with reference to FIGS. 1 and 7. wireless device 805 may include receiver 810, base station device capability manager 815, and transmitter 820. wireless device 805 may also include a processor. Each of these components may be in communication with one another (e.g., via one or more buses).

Receiver 810 may receive information such as packets, user data, or control information associated with various information channels (e.g., control channels, data channels, and information related to enhanced UE capability determination, etc.). Information may be passed on to other components of the device. The receiver 810 may be an example of aspects of the transceiver 1035 described with reference to FIG. 10.

Base station device capability manager 815 may be an example of aspects of the base station device capability manager 1015 described with reference to FIG. 10.

Base station device capability manager 815 may also include capability identifier 825. Capability identifier 825 may identify CA band combinations supportable by the base station. The supported CA band combinations may each be associated with specific MIMO modes or other features.

Transmitter 820 may transmit signals generated by other components of the device. In some examples, the transmitter 820 may be collocated with a receiver 810 in a transceiver module. For example, the transmitter 820 may be an example of aspects of the transceiver 1035 described with reference to FIG. 10. The transmitter 820 may include a single antenna, or it may include a set of antennas.

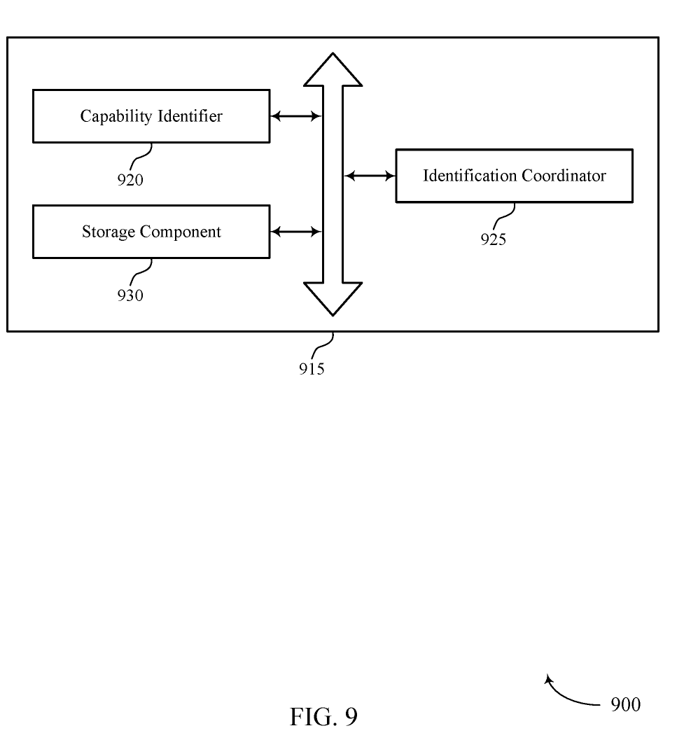

FIG. 9 shows a block diagram 900 of a base station device capability manager 915 that supports enhanced UE capability determination in accordance with various aspects of the present disclosure. The base station device capability manager 915 may be an example of aspects of a base station device capability manager 715, a base station device capability manager 815, or a base station device capability manager 1015 described with reference to FIGS. 7, 8, and 10. The base station device capability manager 915 may include capability identifier 920, identification coordinator 925, and storage component 930. Each of these modules may communicate, directly or indirectly, with one another (e.g., via one or more buses).

Capability identifier 920 may identify CA band combinations (with associated features such as supported MIMO modes) supportable by the base station.

Identification coordinator 925 may include in the UE capability request an identifier corresponding to the UE or is unique to the capability procedure between the UE and the base station; and generate the identifier based on a base station identifier of the base station or a random number generated by the base station.

Storage component 930 may store indications of UE capability and aggregate the indications of UE capability received in a first UE capability response and in a second UE capability response based on an aggregation indicator included in the second UE capability response and associated with the identifier.

FIG. 10 shows a diagram of a system 1000 including a device 1005 that supports enhanced UE capability determination in accordance with various aspects of the present disclosure. Device 1005 may be an example of or include the components of wireless device 705, wireless device 805, or a base station 105 as described above, e.g., with reference to FIGS. 1, 7 and 8. Device 1005 may include components for bi-directional voice and data communications including components for transmitting and receiving communications, including base station device capability manager 1015, processor 1020, memory 1025, software 1030, transceiver 1035, antenna 1040, network communications manager 1045, and base station communications manager 1050. These components may be in electronic communication via one or more busses (e.g., bus 1010). Device 1005 may communicate wirelessly with one or more UEs 115.

Processor 1020 may include an intelligent hardware device, (e.g., a general-purpose processor, a DSP, a central processing unit (CPU), a microcontroller, an ASIC, an FPGA, a programmable logic device, a discrete gate or transistor logic component, a discrete hardware component, or any combination thereof). In some cases, processor 1020 may be configured to operate a memory array using a memory controller. In other cases, a memory controller may be integrated into processor 1020. Processor 1020 may be configured to execute computer-readable instructions stored in a memory to perform various functions (e.g., functions or tasks supporting enhanced UE capability determination).

Memory 1025 may include random access memory (RAM) and read only memory (ROM). The memory 1025 may store computer-readable, computer-executable software 1030 including instructions that, when executed, cause the processor to perform various functions described herein. In some cases, the memory 1025 may contain, among other things, a basic input/output system (BIOS) which may control basic hardware and/or software operation such as the interaction with peripheral components or devices.

Software 1030 may include code to implement aspects of the present disclosure, including code to support enhanced UE capability determination. Software 1030 may be stored in a non-transitory computer-readable medium such as system memory or other memory. In some cases, the software 1030 may not be directly executable by the processor but may cause a computer (e.g., when compiled and executed) to perform functions described herein.

Transceiver 1035 may communicate bi-directionally, via one or more antennas, wired, or wireless links as described above. For example, the transceiver 1035 may represent a wireless transceiver and may communicate bi-directionally with another wireless transceiver. The transceiver 1035 may also include a modem to modulate the packets and provide the modulated packets to the antennas for transmission, and to demodulate packets received from the antennas.

In some cases, the wireless device may include a single antenna 1040. However, in some cases the device may have more than one antenna 1040, which may be capable of concurrently transmitting or receiving multiple wireless transmissions.

Network communications manager 1045 may manage communications with the core network (e.g., via one or more wired backhaul links). For example, the network communications manager 1045 may manage the transfer of data communications for client devices, such as one or more UEs 115.

Base station communications manager 1050 may manage communications with other base station 105, and may include a controller or scheduler for controlling communications with UEs 115 in cooperation with other base stations 105. For example, the base station communications manager 1050 may coordinate scheduling for transmissions to UEs 115 for various interference mitigation techniques such as beamforming or joint transmission. In some examples, base station communications manager 1050 may provide an X2 interface within an LTE/LTE-A wireless communication network technology to provide communication between base stations 105.

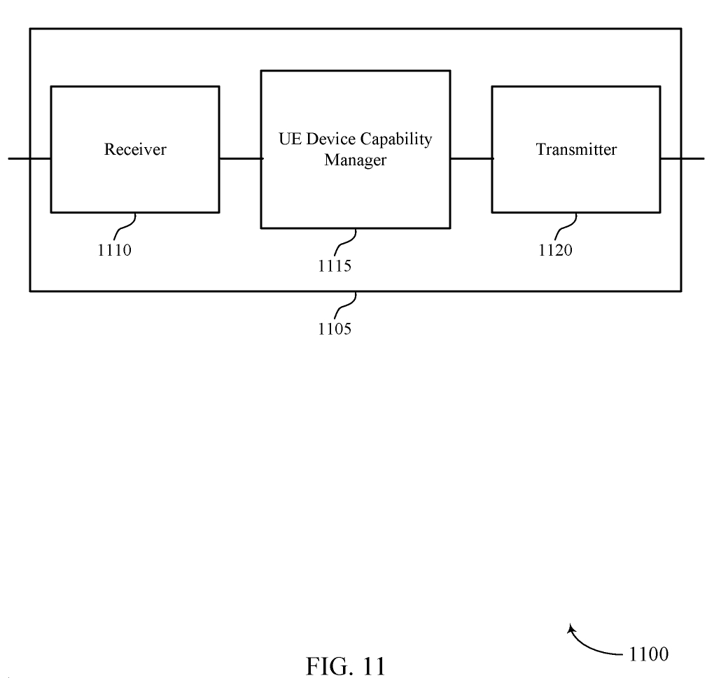

FIG. 11 shows a block diagram 1100 of a wireless device 1105 that supports enhanced UE capability determination in accordance with various aspects of the present disclosure. Wireless device 1105 may be an example of aspects of a UE 115 as described with reference to FIG. 1. wireless device 1105 may include receiver 1110, UE device capability manager 1115, and transmitter 1120. wireless device 1105 may also include a processor. Each of these components may be in communication with one another (e.g., via one or more buses).

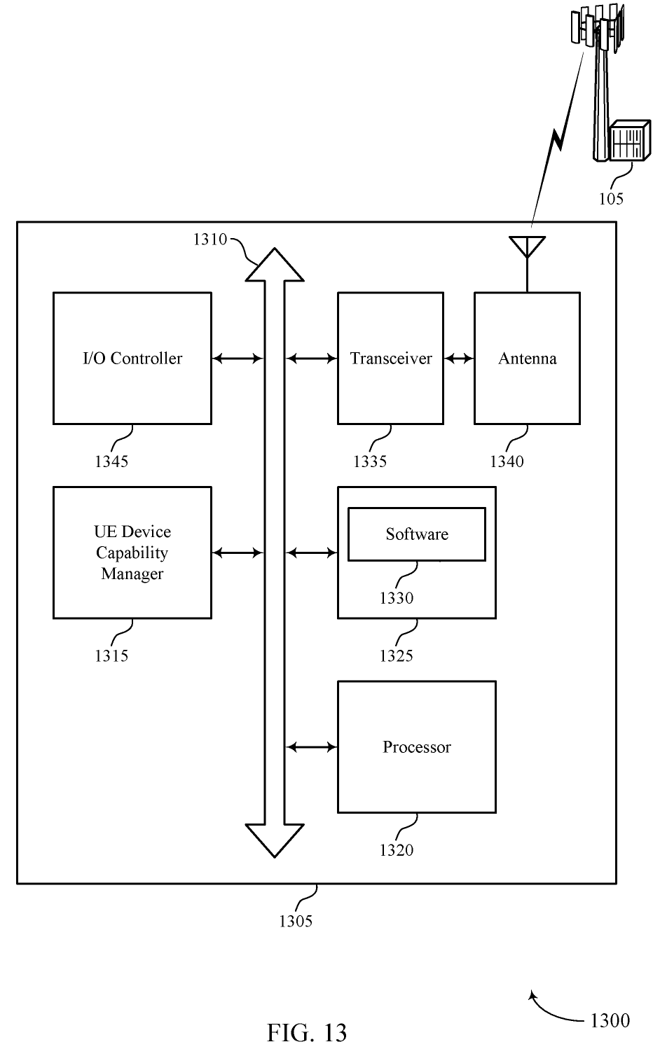

Receiver 1110 may receive information such as packets, user data, or control information associated with various information channels (e.g., control channels, data channels, and information related to enhanced UE capability determination, etc.). Information may be passed on to other components of the device. The receiver 1110 may be an example of aspects of the transceiver 1335 described with reference to FIG. 13.

Receiver 1110 may receive a UE capability request as part of a capability procedure, the UE capability request including one or more indices corresponding to one or more CA band combinations supportable by the base station; and receive an identifier corresponding to the UE or is unique to the capability procedure between the UE and the base station.

UE device capability manager 1115 may be an example of aspects of the UE device capability manager 1315 described with reference to FIG. 13. UE device capability manager 1115 may function in conjunction with receiver 1110 and transmitter 1120 to receive a UE capability request, determine UE capabilities, and respond to the request with corresponding UE capabilities in a UE capability response.

UE device capability manager 1115 and/or at least some of its various sub-components may be implemented in hardware, software executed by a processor, firmware, or any combination thereof. If implemented in software executed by a processor, the functions of the UE device capability manager 1115 and/or at least some of its various sub-components may be executed by a general-purpose processor, a DSP, an ASIC, an FPGA or other programmable logic device, discrete gate or transistor logic, discrete hardware components, or any combination thereof designed to perform the functions described in the present disclosure. The UE device capability manager 1115 and/or at least some of its various sub-components may be physically located at various positions, including being distributed such that portions of functions are implemented at different physical locations by one or more physical devices. In some examples, UE device capability manager 1115 and/or at least some of its various sub-components may be a separate and distinct component in accordance with various aspects of the present disclosure. In other examples, UE device capability manager 1115 and/or at least some of its various sub-components may be combined with one or more other hardware components, including but not limited to an I/O component, a transceiver, a network server, another computing device, one or more other components described in the present disclosure, or a combination thereof in accordance with various aspects of the present disclosure.

Transmitter 1120 may transmit signals generated by other components of the device. In some examples, the transmitter 1120 may be collocated with a receiver 1110 in a transceiver module. For example, the transmitter 1120 may be an example of aspects of the transceiver 1335 described with reference to FIG. 13. The transmitter 1120 may include a single antenna, or it may include a set of antennas.

Transmitter 1120 may transmit a UE capability response that includes one or more indications of UE capability corresponding to the one or more indices; transmit an identifier and an aggregation indicator indicating whether the one or more indications of UE capability in the UE capability response are to be aggregated with additional indications of UE capability in previously transmitted UE capability responses that include the identifier; transmit additional indications of UE capability that do not correspond to the indices; and transmit additional indications of UE capability in a non-critical extension of the UE capability response.

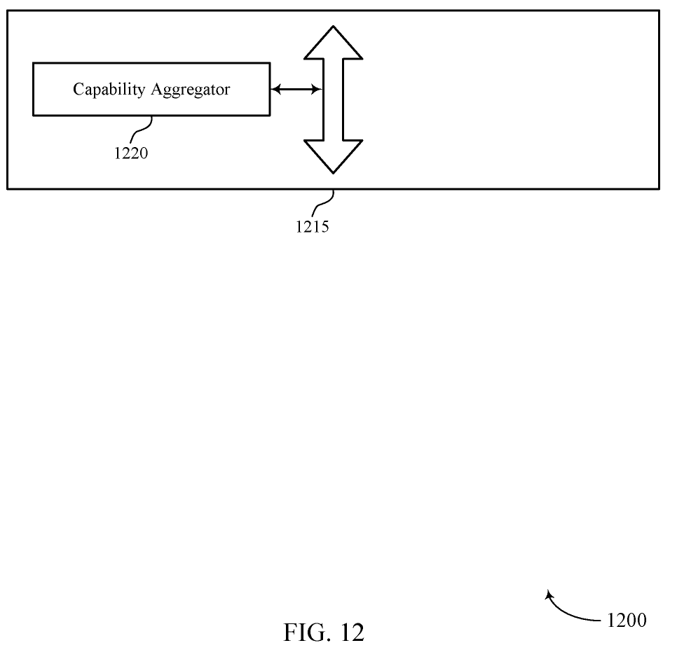

FIG. 12 shows a block diagram 1200 of a UE device capability manager 1215 that supports enhanced UE capability determination in accordance with various aspects of the present disclosure. The UE device capability manager 1215 may be an example of aspects of a UE device capability manager 1315 described with reference to FIGS. 11, 12, and 13. The UE device capability manager 1215 may include capability aggregator 1220. Each of these modules may communicate, directly or indirectly, with one another (e.g., via one or more buses).

Capability aggregator 1220 may indicate in at least the second UE capability response that the one or more indications of UE capability included in the first UE capability response and in the second UE capability response are to be aggregated.

FIG. 13 shows a diagram of a system 1300 including a device 1305 that supports enhanced UE capability determination in accordance with various aspects of the present disclosure. Device 1305 may be an example of or include the components of UE 115 as described above, e.g., with reference to FIG. 1. Device 1305 may include components for bi-directional voice and data communications including components for transmitting and receiving communications, including UE device capability manager 1315, processor 1320, memory 1325, software 1330, transceiver 1335, antenna 1340, and I/O controller 1345. These components may be in electronic communication via one or more busses (e.g., bus 1310). Device 1305 may communicate wirelessly with one or more base stations 105.

Processor 1320 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 1320 may be configured to operate a memory array using a memory controller. In other cases, a memory controller may be integrated into processor 1320. Processor 1320 may be configured to execute computer-readable instructions stored in a memory to perform various functions (e.g., functions or tasks supporting enhanced UE capability determination).

Memory 1325 may include RAM and ROM. The memory 1325 may store computer-readable, computer-executable software 1330 including instructions that, when executed, cause the processor to perform various functions described herein. In some cases, the memory 1325 may contain, among other things, a BIOS which may control basic hardware and/or software operation such as the interaction with peripheral components or devices.

Software 1330 may include code to implement aspects of the present disclosure, including code to support enhanced UE capability determination. Software 1330 may be stored in a non-transitory computer-readable medium such as system memory or other memory. In some cases, the software 1330 may not be directly executable by the processor but may cause a computer (e.g., when compiled and executed) to perform functions described herein.

Transceiver 1335 may communicate bi-directionally, via one or more antennas, wired, or wireless links as described above. For example, the transceiver 1335 may represent a wireless transceiver and may communicate bi-directionally with another wireless transceiver. The transceiver 1335 may also include a modem to modulate the packets and provide the modulated packets to the antennas for transmission, and to demodulate packets received from the antennas.

In some cases, the wireless device may include a single antenna 1340. However, in some cases the device may have more than one antenna 1340, which may be capable of concurrently transmitting or receiving multiple wireless transmissions.

I/O controller 1345 may manage input and output signals for device 1305. I/O controller 1345 may also manage peripherals not integrated into device 1305. In some cases, I/O controller 1345 may represent a physical connection or port to an external peripheral. In some cases, I/O controller 1345 may utilize an operating system such as iOS®, ANDROID®, MS-DOS®, MS-WINDOWS®, OS/2®, UNIX®, LINUX®, or another known operating system. In other cases, I/O controller 1345 may represent or interact with a modem, a keyboard, a mouse, a touchscreen, or a similar device. In some cases, I/O controller 1345 may be implemented as part of a processor. In some cases, a user may interact with device 1305 via I/O controller 1345 or via hardware components controlled by I/O controller 1345.

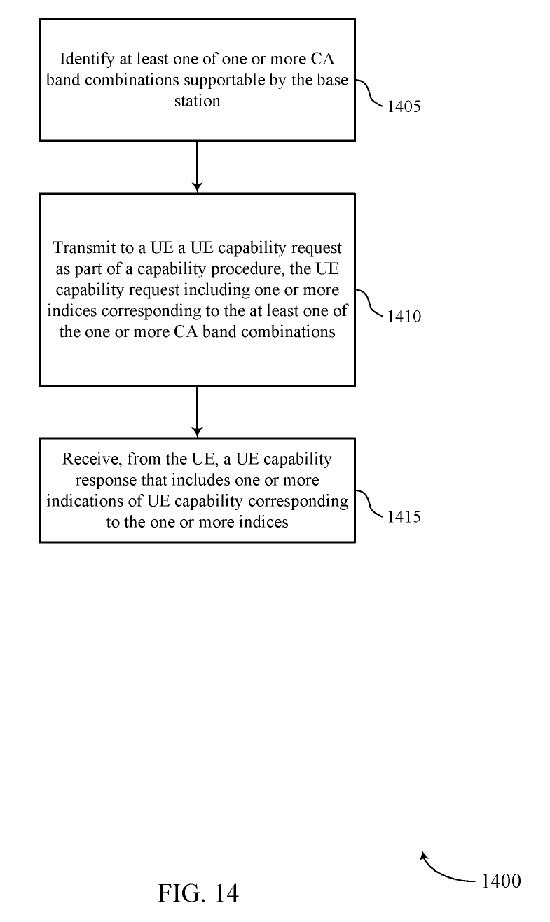

FIG. 14 shows a flowchart illustrating a method 1400 for enhanced UE capability determination in accordance with various aspects of the present disclosure. The operations of method 1400 may be implemented by a base station 105 or its components as described herein. For example, the operations of method 1400 may be performed by a base station device capability manager as described with reference to FIGS. 7 through 10. In some examples, a base station 105 may execute a set of codes to control the functional elements of the device to perform the functions described below. Additionally or alternatively, the base station 105 may perform aspects of the functions described below using special-purpose hardware.

At block 1405 the base station 105 may identify CA band combinations that are supportable by the base station 105. The operations of block 1405 may be performed according to the methods described with reference to FIGS. 1 through 6. In certain examples, aspects of the operations of block 1405 may be performed by a capability identifier as described with reference to FIGS. 7 through 10.

At block 1410 the base station 105 may transmit a UE capability request as part of a capability procedure, the UE capability request including indices corresponding to the identified CA band combinations. The operations of block 1410 may be performed according to the methods described with reference to FIGS. 1 through 6. In certain examples, aspects of the operations of block 1410 may be performed by a transmitter as described with reference to FIGS. 7 through 10.

At block 1415 the base station 105 may receive a UE capability response that includes indications of UE capability corresponding to the transmitted indices. The operations of block 1415 may be performed according to the methods described with reference to FIGS. 1 through 6. In certain examples, aspects of the operations of block 1415 may be performed by a receiver as described with reference to FIGS. 7 through 10.

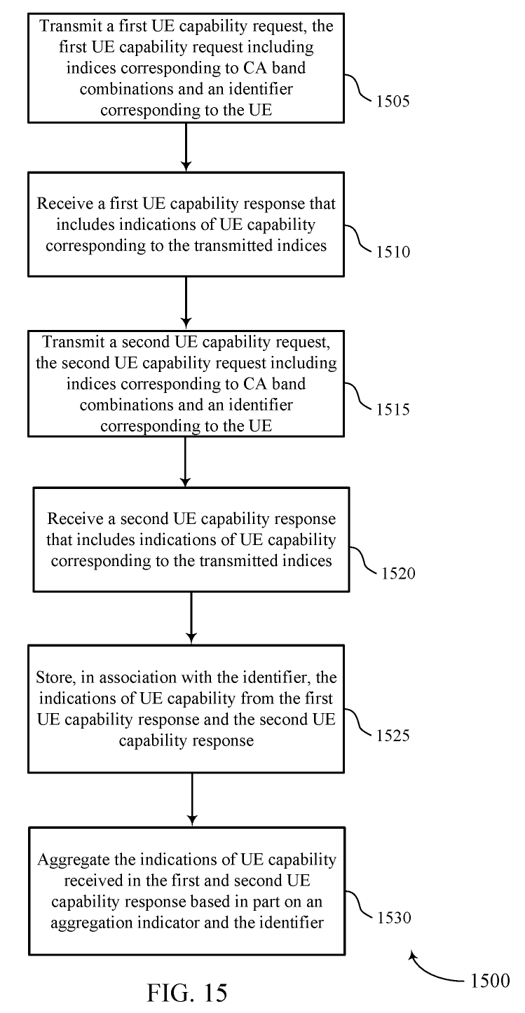

FIG. 15 shows a flowchart illustrating a method 1500 for enhanced UE capability determination in accordance with various aspects of the present disclosure. The operations of method 1500 may be implemented by a base station 105 or its components as described herein. For example, the operations of method 1500 may be performed by a base station device capability manager as described with reference to FIGS. 7 through 10. In some examples, a base station 105 may execute a set of codes to control the functional elements of the device to perform the functions described below. Additionally or alternatively, the base station 105 may perform aspects of the functions described below using special-purpose hardware.

At block 1505 the base station 105 may transmit a first UE capability request, the first UE capability request including indices corresponding to CA band combinations and an identifier corresponding to the UE. The operations of block 1505 may be performed according to the methods described with reference to FIGS. 1 through 6. In certain examples, aspects of the operations of block 1505 may be performed by a transmitter as described with reference to FIGS. 7 through 10.

At block 1510 the base station 105 may receive a first UE capability response that includes indications of UE capability corresponding to the transmitted indices. The operations of block 1510 may be performed according to the methods described with reference to FIGS. 1 through 6. In certain examples, aspects of the operations of block 1510 may be performed by a receiver as described with reference to FIGS. 7 through 10.

At block 1515 the base station 105 may transmit a second UE capability request, the second UE capability request including indices corresponding to CA band combinations and an identifier corresponding to the UE. The operations of block 1515 may be performed according to the methods described with reference to FIGS. 1 through 6. In certain examples, aspects of the operations of block 1515 may be performed by a transmitter as described with reference to FIGS. 7 through 10.

At block 1520 the base station 105 may receive a second UE capability response that includes indications of UE capability corresponding to the transmitted indices. The operations of block 1520 may be performed according to the methods described with reference to FIGS. 1 through 6. In certain examples, aspects of the operations of block 1520 may be performed by a receiver as described with reference to FIGS. 7 through 10.

At block 1525 the base station 105 may store, in association with the identifier, the indications of UE capability from the first UE capability response and the second UE capability response. The operations of block 1525 may be performed according to the methods described with reference to FIGS. 1 through 6. In certain examples, aspects of the operations of block 1525 may be performed by a storage component as described with reference to FIGS. 7 through 10.

At block 1530 the base station 105 may aggregate the indications of UE capability received in the first and second UE capability response based in part on an aggregation indicator and the identifier. The operations of block 1530 may be performed according to the methods described with reference to FIGS. 1 through 6. In certain examples, aspects of the operations of block 1525 may be performed by a storage component as described with reference to FIGS. 7 through 10.

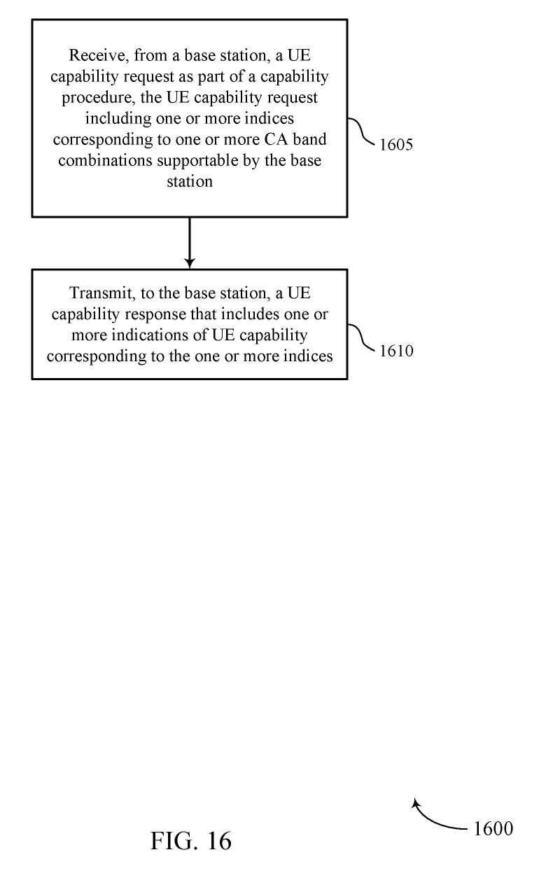

FIG. 16 shows a flowchart illustrating a method 1600 for enhanced UE capability determination in accordance with various aspects of the present disclosure. The operations of method 1600 may be implemented by a UE 115 or its components as described herein. For example, the operations of method 1600 may be performed by a UE device capability manager as described with reference to FIGS. 11 through 13. In some examples, a UE 115 may execute a set of codes to control the functional elements of the device to perform the functions described below. Additionally or alternatively, the UE 115 may perform aspects of the functions described below using special-purpose hardware.

At block 1605 the UE 115 may receive a UE capability request as part of a capability procedure, the UE capability request including indices corresponding to CA band combinations supportable by a base station. The operations of block 1605 may be performed according to the methods described with reference to FIGS. 1 through 6. In certain examples, aspects of the operations of block 1605 may be performed by a receiver as described with reference to FIGS. 11 through 13.

At block 1610 the UE 115 may transmit a UE capability response that includes indications of UE capability corresponding to the indices. The operations of block 1610 may be performed according to the methods described with reference to FIGS. 1 through 6. In certain examples, aspects of the operations of block 1610 may be performed by a transmitter as described with reference to FIGS. 11 through 13.

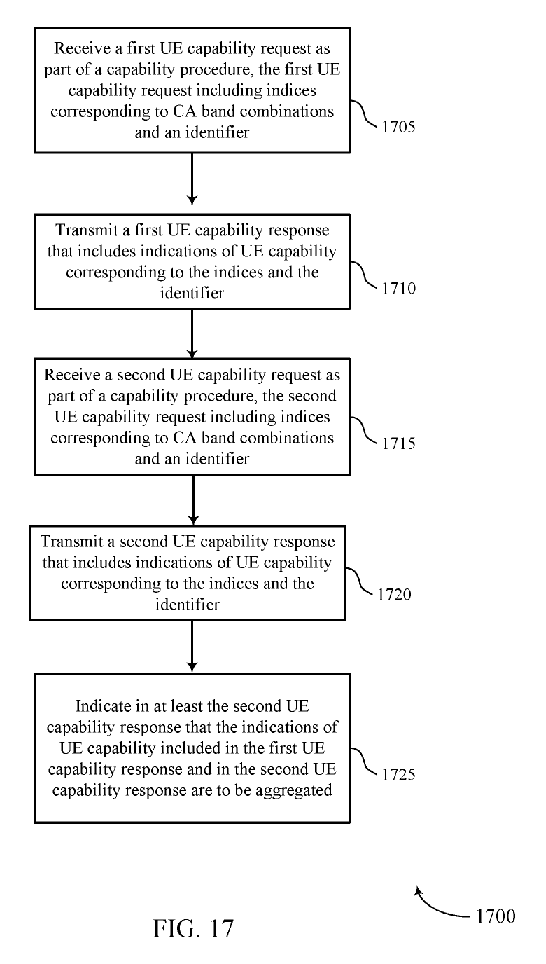

FIG. 17 shows a flowchart illustrating a method 1700 for enhanced UE capability determination in accordance with various aspects of the present disclosure. The operations of method 1700 may be implemented by a UE 115 or its components as described herein. For example, the operations of method 1700 may be performed by a UE device capability manager as described with reference to FIGS. 11 through 13. In some examples, a UE 115 may execute a set of codes to control the functional elements of the device to perform the functions described below. Additionally or alternatively, the UE 115 may perform aspects of the functions described below using special-purpose hardware.

At block 1705 the UE 115 may receive a first UE capability request as part of a capability procedure, the first UE capability request including indices corresponding to CA band combinations and an identifier. The operations of block 1705 may be performed according to the methods described with reference to FIGS. 1 through 6. In certain examples, aspects of the operations of block 1705 may be performed by a receiver as described with reference to FIGS. 11 through 13.

At block 1710 the UE 115 may transmit a first UE capability response that includes indications of UE capability corresponding to the indices and the identifier. The operations of block 1710 may be performed according to the methods described with reference to FIGS. 1 through 6. In certain examples, aspects of the operations of block 1710 may be performed by a transmitter as described with reference to FIGS. 11 through 13.

At block 1715 the UE 115 may receive a second UE capability request as part of a capability procedure, the second UE capability request including indices corresponding to CA band combinations and an identifier. The operations of block 1715 may be performed according to the methods described with reference to FIGS. 1 through 6. In certain examples, aspects of the operations of block 1715 may be performed by a receiver as described with reference to FIGS. 11 through 13.

At block 1720 the UE 115 may transmit a second UE capability response that includes indications of UE capability corresponding to the indices and the identifier. In certain examples, aspects of the operations of block 1710 may be performed by a transmitter as described with reference to FIGS. 11 through 13.

At block 1725 the UE 115 may indicate in at least the second UE capability response that the indications of UE capability included in the first UE capability response and in the second UE capability response are to be aggregated. The operations of block 1720 may be performed according to the methods described with reference to FIGS. 1 through 6. In certain examples, aspects of the operations of block 1720 may be performed by a capability aggregator as described with reference to FIGS. 11 through 13.

It should be noted that the methods described above describe possible implementations, and that the operations and the steps may be rearranged or otherwise modified and that other implementations are possible. Furthermore, aspects from two or more of the methods may be combined.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A code division multiple access (CDMA) system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A time division multiple access (TDMA) system may implement a radio technology such as Global System for Mobile Communications (GSM).

An orthogonal frequency division multiple access (OFDMA) system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications system (UMTS). 3GPP Long Term Evolution (LTE) and LTE-Advanced (LTE-A) are releases of Universal Mobile Telecommunications System (UMTS) that use E-UTRA. UTRA, E-UTRA, UMTS, LTE, LTE-A, NR, and Global System for Mobile communications (GSM) are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. While aspects an LTE or an NR system may be described for purposes of example, and LTE or NR terminology may be used in much of the description, the techniques described herein are applicable beyond LTE or NR applications.

In LTE/LTE-A networks, including such networks described herein, the term evolved node B (eNB) may be generally used to describe the base stations. The wireless communications system or systems described herein may include a heterogeneous LTE/LTE-A or NR network in which different types of evolved node B (eNBs) provide coverage for various geographical regions. For example, each eNB, gNB or base station may provide communication coverage for a macro cell, a small cell, or other types of cell. The term “cell” may be used to describe a base station, a carrier or component carrier associated with a base station, or a coverage area (e.g., sector, etc.) of a carrier or base station, depending on context.

Base stations may include or may be referred to by those skilled in the art as a base transceiver station, a radio base station, an access point, a radio transceiver, a NodeB, eNodeB (eNB), next generation NodeB (gNB), Home NodeB, a Home eNodeB, or some other suitable terminology. The geographic coverage area for a base station may be divided into sectors making up only a portion of the coverage area. The wireless communications system or systems described herein may include base stations of different types (e.g., macro or small cell base stations). The UEs described herein may be able to communicate with various types of base stations and network equipment including macro eNBs, small cell eNBs, gNBs, relay base stations, and the like. There may be overlapping geographic coverage areas for different technologies.

A macro cell generally covers a relatively large geographic area (e.g., several kilometers in radius) and may allow unrestricted access by UEs with service subscriptions with the network provider. A small cell is a lower-powered base station, as compared with a macro cell, that may operate in the same or different (e.g., licensed, unlicensed, etc.) frequency bands as macro cells. Small cells may include pico cells, femto cells, and micro cells according to various examples. A pico cell, for example, may cover a small geographic area and may allow unrestricted access by UEs with service subscriptions with the network provider. A femto cell may also cover a small geographic area (e.g., a home) and may provide restricted access by UEs having an association with the femto cell (e.g., UEs in a closed subscriber group (CSG), UEs for users in the home, and the like). An eNB for a macro cell may be referred to as a macro eNB. An eNB for a small cell may be referred to as a small cell eNB, a pico eNB, a femto eNB, or a home eNB. An eNB may support one or multiple (e.g., two, three, four, and the like) cells (e.g., component carriers).

The wireless communications system or systems described herein may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The downlink transmissions described herein may also be called forward link transmissions while the uplink transmissions may also be called reverse link transmissions. Each communication link described herein—including, for example, wireless communications system 100 and 200 of FIGS. 1 and 2—may include one or more carriers, where each carrier may be a signal made up of multiple sub-carriers (e.g., waveform signals of different frequencies).

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless communication at a base station, comprising:
identifying at least one of one or more carrier aggregation (CA) band combinations supportable by the base station;
transmitting to a user equipment (UE) a UE capability request as part of a capability procedure, the UE capability request including one or more indices corresponding to the at least one of one or more CA band combinations; and
receiving, from the UE, a UE capability response that includes one or more indications of UE capability corresponding to the one or more indices.

2. The method of claim 1, further comprising:
including in the UE capability request an identifier corresponding to the UE; and
receiving, in the UE capability response, the identifier and an aggregation indicator indicating whether the one or more indications of UE capability in the UE capability response are to be aggregated with additional indications of UE capability in previously received UE capability responses that include the identifier.

3. The method of claim 1, wherein transmitting the UE capability request comprises:
transmitting a first UE capability request that includes a first set of the one or more indices corresponding to a first set of the at least one of one or more CA band combinations; and
transmitting a second UE capability request that includes a second set of the one or more indices corresponding to a second set of the at least one of one or more CA band combinations, and
including an identifier corresponding to the UE in both the first UE capability request and the second UE capability request.

4. The method of claim 3, wherein receiving the UE capability response comprises:
receiving a first UE capability response and a second UE capability response; and
storing, in association with the identifier, the one or more indications of UE capability from at least one of the first UE capability response or the second UE capability response.

5. The method of claim 4, further comprising:
aggregating the one or more indications of UE capability received in the first UE capability response and in the second UE capability response based at least in part on an aggregation indicator included in the second UE capability response and associated with the identifier.

6. The method of claim 1, further comprising:
including in the UE capability request an identifier that corresponds with and is unique to the capability procedure between the UE and the base station.

7. The method of claim 6, further comprising:
generating the identifier based at least in part on at least one of a base station identifier of the base station or a random number generated by the base station.

8. The method of claim 1, wherein:
the one or more indications of UE capability are each one bit.

9. The method of claim 1, further comprising:
receiving, in the UE capability response, one or more additional indications of UE capability that do not correspond to the one or more indices.

10. The method of claim 9, further comprising:
receiving the one or more additional indications of UE capability in a non-critical extension of the UE capability response.

11. The method of claim 1, wherein the at least one of the one or more CA band combinations to which the indices correspond is associated with one or more supported multiple input multiple output (MIMO) modes.

12. The method of claim 1, further comprising:
receiving, in the UE capability response, at least one of an identifier or an aggregation indicator indicating whether the one or more indications of UE capability in the UE capability response are to be aggregated with additional indications of UE capability in previously received UE capability responses that include the identifier.

13. A method for wireless communication at a user equipment (UE), comprising:
receiving, from a base station, a UE capability request as part of a capability procedure, the UE capability request including one or more indices corresponding to one or more carrier aggregation (CA) band combinations supportable by the base station; and
transmitting, to the base station, a UE capability response that includes one or more indications of UE capability corresponding to the one or more indices.

14. The method of claim 13, further comprising:
receiving in the UE capability request an identifier corresponding to the UE; and
transmitting, in the UE capability response, the identifier and an aggregation indicator indicating whether the one or more indications of UE capability in the UE capability response are to be aggregated with additional indications of UE capability in previously transmitted UE capability responses that include the identifier.

15. The method of claim 13, wherein receiving the UE capability request comprises:
receiving a first UE capability request that includes a first set of the one or more indices corresponding to a first set of the at least one of one or more CA band combinations; and
receiving a second UE capability request that includes a second set of the one or more indices corresponding to a second set of the at least one of one or more CA band combinations, wherein an identifier is included in both the first UE capability request and the second UE capability request.

16. The method of claim 15, wherein transmitting the UE capability response comprises:
transmitting a first UE capability response and a second UE capability response, both the first UE capability response and the second UE capability response including the identifier; and
indicating in at least the second UE capability response that the one or more indications of UE capability included in the first UE capability response and in the second UE capability response are to be aggregated.

17. The method of claim 13, further comprising:
receiving in the UE capability request an identifier that corresponds with and is unique to the capability procedure between the UE and the base station.

18. The method of claim 13, wherein:
the one or more indications of UE capability are each one bit.

19. The method of claim 13, further comprising:
transmitting, in the UE capability response, one or more additional indications of UE capability that do not correspond to the one or more indices.

20. The method of claim 19, further comprising:
transmitting the one or more additional indications of UE capability in a non-critical extension of the UE capability response.

21. The method of claim 13, wherein the at least one of the one or more CA band combinations to which the indices correspond is associated with one or more supported multiple input multiple output (MIMO) modes.

22. The method of claim 13, further comprising:
transmitting, in the UE capability response, at least one of an identifier or an aggregation indicator indicating whether the one or more indications of UE capability in the UE capability response are to be aggregated with additional indications of UE capability in previously transmitted UE capability responses that include the identifier.

23. An apparatus for wireless communication, in a system comprising:
a processor;
memory in electronic communication with the processor; and
instructions stored in the memory and operable, when executed by the processor, to cause the apparatus to:
identify at least one of one or more carrier aggregation (CA) band combinations supportable by the base station;
transmit to a user equipment (UE) a UE capability request as part of a capability procedure, the UE capability request including one or more indices corresponding to the at least one of one or more CA band combinations; and
receive, from the UE, a UE capability response that includes one or more indications of UE capability corresponding to the one or more indices.

24. The apparatus of claim 23, wherein the instructions are further executable by the processor to:
include in the UE capability request an identifier corresponding to the UE; and
receive, in the UE capability response, the identifier and an aggregation indicator indicating whether the one or more indications of UE capability in the UE capability response are to be aggregated with additional indications of UE capability in previously received UE capability responses that include the identifier.

25. The apparatus of claim 23, wherein the instructions to transmit the UE capability request are further executable by the processor to:
transmit a first UE capability request that includes a first set of the one or more indices corresponding to a first set of the at least one of one or more CA band combinations;
transmit a second UE capability request that includes a second set of the one or more indices corresponding to a second set of the at least one of one or more CA band combinations, and
include an identifier corresponding to the UE in both the first UE capability request and the second UE capability request.

26. The apparatus of claim 25, wherein the instructions to receive the UE capability response are further executable by the processor to:
receive a first UE capability response and a second UE capability response;
store, in association with the identifier, the one or more indications of UE capability from at least one of the first UE capability response or the second UE capability response; and
aggregate the one or more indications of UE capability received in the first UE capability response and in the second UE capability response based at least in part on an aggregation indicator included in the second UE capability response and associated with the identifier.

27. An apparatus for wireless communication, in a system comprising:
a processor;
memory in electronic communication with the processor; and
instructions stored in the memory and operable, when executed by the processor, to cause the apparatus to:
receive, from a base station, a user equipment (UE) capability request as part of a capability procedure, the UE capability request including one or more indices corresponding to one or more carrier aggregation (CA) band combinations supportable by the base station; and
transmit, to the base station, a UE capability response that includes one or more indications of UE capability corresponding to the one or more indices.

28. The apparatus of claim 27, wherein the instructions are further executable by the processor to:
receive in the UE capability request an identifier corresponding to the UE; and
transmit, in the UE capability response, the identifier and an aggregation indicator indicating whether the one or more indications of UE capability in the UE capability response are to be aggregated with additional indications of UE capability in previously transmitted UE capability responses that include the identifier.

29. The apparatus of claim 27, wherein the instructions to receive the UE capability request are further executable by the processor to:
receive a first UE capability request that includes a first set of the one or more indices corresponding to a first set of the at least one of one or more CA band combinations; and
receive a second UE capability request that includes a second set of the one or more indices corresponding to a second set of the at least one of one or more CA band combinations, wherein an identifier is included in both the first UE capability request and the second UE capability request.

30. The apparatus of claim 29, wherein the instructions to transmit the UE capability response are further executable by the processor to:
transmit a first UE capability response and a second UE capability response, both the first UE capability response and the second UE capability response including the identifier; and
indicate in at least the second UE capability response that the one or more indications of UE capability included in the first UE capability response and in the second UE capability response are to be aggregated.
